(19) United States
(12) Patent Application Publication
(10) Pub. No.: US 2010/0033411 A1
(43) Pub. Date: Feb. 11, 2010

(54) SOURCE DRIVER WITH PLURAL-FEEDBACK-LOOP OUTPUT BUFFER

(76) Inventor: Ching-Chung Lee, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/185,822

(22) Filed: Aug. 5, 2008

(51) Int. Cl. G09G 3/36

(52) U.S. Cl. 345/87

(57) ABSTRACT

A source driver of a display includes a first channel. The first channel includes a first amplifier, a first output switch, and a first feedback loop. The first output switch selectively connects an output node of the first amplifier to one of output pads of the source driver. The first feedback switch connects an input node of the first amplifier to one of the output pads or the output node of the first amplifier.

### BACKGROUND OF THE INVENTION

1. Field of the Invention

The invention relates to a liquid crystal display (LCD), and more particularly to a source driver with an output buffer with plural feedback loops.

2. Description of the Prior Art

Liquid crystal displays (LCDs) have led us to a brave new visual world for their small size, light weight, and extensive display capabilities. One important subject in evaluating the display capability of an LCD is its response time. An LCD having a shorter response time can clearly display fast-moving objects, whereas an LCD having a longer response time would create a smear or blur pattern around moving objects, making them unacceptable for viewing moving video. To improve the response time of the LCD, an important issue is to improve the driving capability of the LCD's source driver. As known by people skilled in the art, the LCD's source driver drives the LCD by charging each pixel of the LCD to a corresponding voltage level.

FIG. 1A shows a diagram of a channel of a source driver 1000. The source driver 1000 has plural channels, and only one channel is illustrated in FIG. 1A as an example. Each channel of the source driver 1000 includes an output multiplexer 1100, a buffer circuit 1200, a D/A converter 1300, a level shifter circuit 1400, a line buffer circuit 1500, and a shift register 1600. The shift register 1600 outputs control signals to the line buffer circuit 1500 for controlling the latching operation of pixel signals, such as D0, D1, and D2. The level shifter 1400 transfers the digital data output from the line buffer 1500 from a low voltage range to a high voltage range. The D/A converter 1300 receives the digital data of the high voltage range for converting them into an analog voltage for driving the corresponding data line DL. The output buffer 1200 provides enough driving ability for outputting the analog voltage to the corresponding data line DL. The output multiplexer 1100 selectively couples the output buffer 1200 to the corresponding data line DL according to a transfer pulse signal (TP1) signal. A bottleneck in improving the driving capability is the charging time of each pixel being dominated by the pixels' capacitive nature. The output buffer 1200 and the output multiplexer 1100 together are called an output stage of the source driver 1000.

FIG. 1B shows an exemplary diagram of the output stage corresponding to a channel of a source driver. The output stage includes the output buffer 1200 and the output multiplexer 1100. The output buffer 1200 includes an amplifier (OP) 110 and the output multiplexer 1100 includes a switch SW for building a transmission path to a corresponding data line DL via an output pad P of the source driver. The OP 110 comprises a positive input node IN+ for receiving an analog voltage and a negative input node IN− coupled to an output node OUT of the OP 110 that builds up a negative feedback loop. The OP 110 drives the data line DL connected to the output pad P of the source driver to a certain voltage level according to the analog voltage. The analog voltage, however, has to be updated frequently to drive different pixels at different times. Hence, switch SW disconnects the output node OUT of the OP 110 from the output pad P of source driver when the analog voltage is being updated and connects the output node OUT of the OP 110 to the output pad P when ready to drive the data line DL according to the updated analog voltage.

When the switch SW is turned on, the output node OUT of the OP 110 is connected to the data line DL, having a loading capacitance C_{LCD}, via the output pad P. The charging time of the pixel will be determined according to the loading capacitance C_{LCD} of the corresponding data line DL, an on-resistance R_{SW} of the switch SW and an output resistance R_{OUT} of the OP 110. The RC-time constant for charging the pixel is equal to the equivalent output resistance of the channel 100 multiplied with the loading capacitance C_{LCD}, about (R_{SW}+R_{OUT}/A_{OP})×C_{LCD}, wherein A_{OP} is the gain of the OP 110. To reduce the RC-time constant, one conventional solution is to reduce the on-resistance R_{SW} of the switch SW, but the size of the transistors forming the switch SW must be increased, resulting in larger area and higher cost.

Another conventional solution is to incorporate the switch SW into the feedback loop. FIG. 2 shows an exemplary diagram of another output stage of a channel of a source driver. The output stage includes the output buffer 1200 and an output multiplexer 1101. The negative input node IN− of the OP 110 is coupled to the output pad P of the source driver. In other words, the switch SW in FIG. 2 is included in the feedback loop. Hence, the RC-time constant of charging the pixel becomes about (R_{SW}/A_{OP}+R_{OUT}/A_{OP}) multiplied by C_{LCD}, i.e., (R_{SW}/A_{OP}+R_{OUT}/A_{OP})×C_{LCD}. As one can see, the RC-time constant could be reduced significantly due to the OP 110's high gain A_{OP}. Equivalently, the bandwidth of the source driver is improved. The architecture of the output stage in FIG. 2, however, has a drawback in that when the switch SW is turned off, the feedback loop is open-circuited for that period. Once the feedback loop is open-circuited, the output voltage of the OP 110, V_{OUT}, will be out of control, and may be extremely high or extremely low since the voltages at the inputs of OP 110 could be different. In addition, the output voltage V_{OUT} may be easily affected by the noise at the inputs of the OP 110.

### SUMMARY OF THE INVENTION

Therefore, one objective of the invention is to provide a source driver with improved driving capability.

According to one exemplary embodiment of the present invention, a source driver of a display comprises a first channel. The first channel comprises a first amplifier, a first output switch, and a first feedback loop. The first output switch selectively connects an output node of the first amplifier to one of the output pads of the source driver. The first feedback switch connects an input node of the first amplifier to one of the output pads or the output node of the first amplifier.

According to another exemplary embodiment of the present invention, the source driver of the display further comprises a second channel. The second channel comprises a second amplifier, a second output switch, and a second feedback loop. The second output switch selectively connects an output node of the second amplifier to one of output pads of the source driver. The second feedback switch connects an input node of the second amplifier to one of the output pads or the output node of the second amplifier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A shows a conventional architecture of a source driver

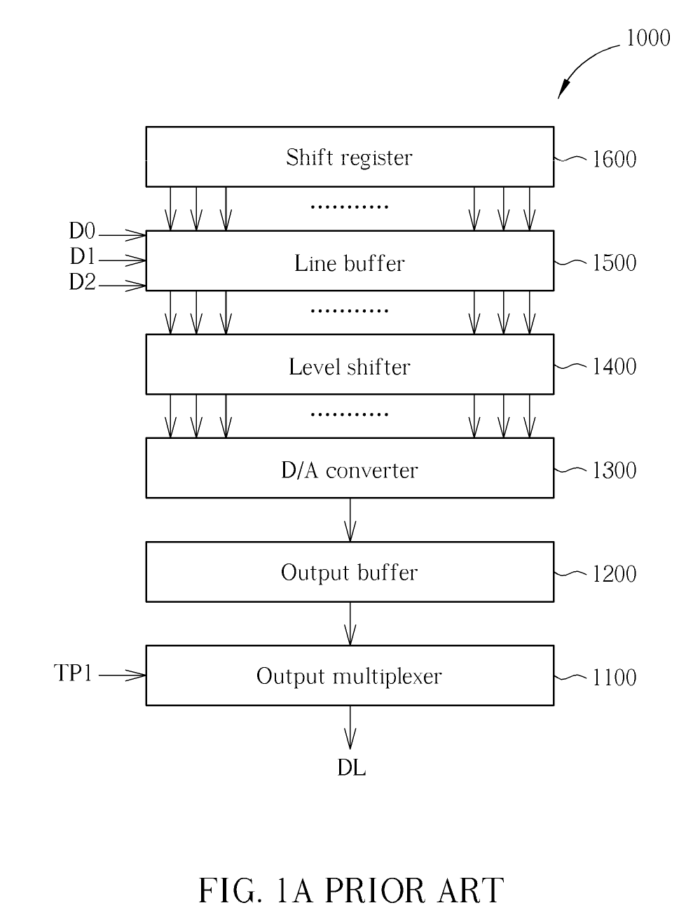

FIG. 1B shows an exemplary diagram of a conventional channel of a source driver.

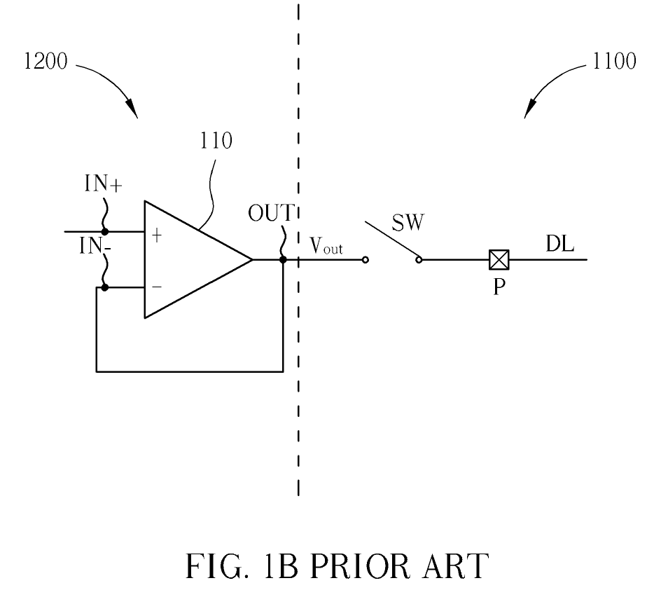

FIG. 2 shows an exemplary diagram of another conventional channel of a source driver.

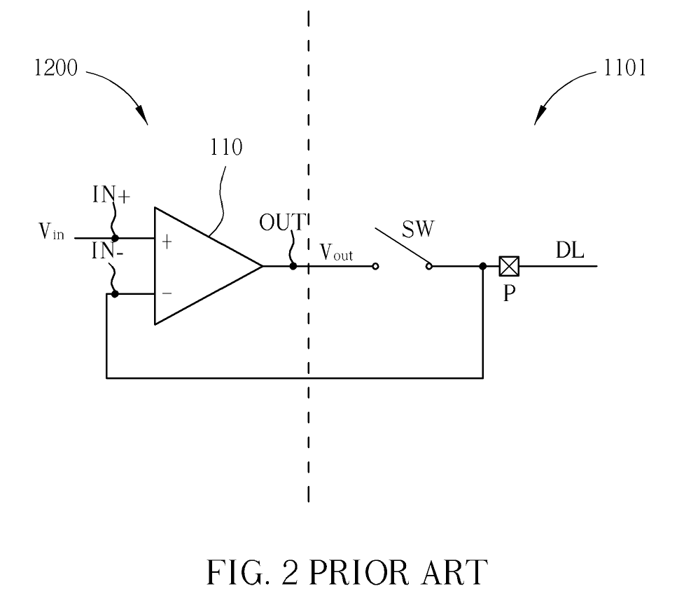

FIG. 3 is an exemplary diagram showing a channel of a source driver of a display according to an embodiment of the invention.

FIG. 4A is an exemplary diagram showing two channels of a source driver of a display according to an embodiment of the invention.

FIG. 4B is an exemplary diagram of a first connection mode of the channels in FIG. 4A.

FIG. 4C is an exemplary diagram of a second connection mode corresponding to a first polarity of the channels in FIG. 4A.

FIG. 4D is an exemplary diagram of a second connection mode corresponding to a second polarity of the channels in FIG. 4A.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections

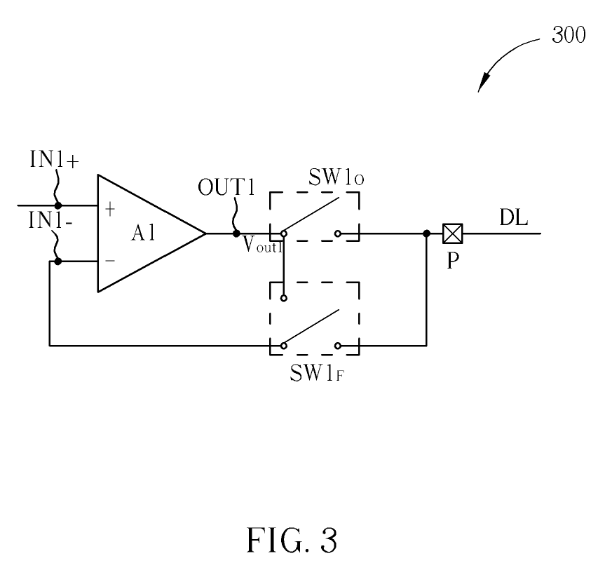

FIG. 3 is an exemplary diagram showing an output stage of a channel 300 of a source driver of a display according to an embodiment of the invention. The display can be any display, such as a flat panel display, a liquid crystal display (LCD) and etc. The output stage of the channel 300 comprises a first amplifier A1, a first output switch SW1_{O}, and a first feedback switch SW1_{F}. The first amplifier A1 includes a positive input node IN1+ for receiving an analog voltage, a negative input node IN1−, and an output node OUT1. The first amplifier A1 can be deemed as a voltage follower and can be implemented using any amplifier having high gain (e.g., an operational amplifier). The switches SW1_{O} and SW1_{F} can be deemed as an output multiplexer. The implementation shown in FIG. 3 merely serves as an example to describe the invention, but it is not meant to be a limitation of the invention. In addition, only the components related to the invention are shown in FIG. 3 for simplicity.

The first amplifier A1 has two feedback loops. One feedback loop includes the first output switch SW1_{O} and the first feedback SW1_{F}. Another feedback loop is simply built by the first feedback SW1_{F}. At least one of these two feedback loops is active when the source driver operates, so that the output voltage of the first amplifier A1 will not be out of control. In addition, all the switches, including the first output switch SW1_{O} and the first feedback SW1_{F}, are included in feedback loops. Hence the equivalent output resistance of the channel 300 can be reduced in a great deal: roughly by A_{A1} times the equivalent output resistance of the channel 300 (where A_{A1} is the gain of the first amplifier A1). Since the equivalent output resistance of the channel 300 is reduced a great deal, so is the RC-time constant of charging the pixel with the channel 300. The operation thereof will be described in detail below.

The first output switch SW1_{O} selectively connects the output node OUT1 to one of output pads of the source driver. The first feedback switch SW1_{F} selectively connects the negative input node IN1− to one of the output pads or the output node OUT1.

In a first connection mode, the channel 300 does not transmit analog voltage to the data line DL, and the feedback loop is simply built by the first feedback switch SW1_{F}. That is, the first output switch SW1_{O} disconnect the output node OUT1 from the output pad P of the source driver according to the first control signal, while the first feedback switch SW1_{F} connects the negative input node IN1− to the output node OUT1 according to the first control signal. At this time, the negative input node IN1− is connected to the output node OUT1 rather than floating. Hence, the output voltage Vₒᵤₜ₁ of the first amplifier is bound to the input voltage at the positive input node IN+. As a result, the first amplifier A1, the channel 300, and even the source driver are in a stable state.

In a second connection mode, the channel 300 outputs the analog voltage Vout1 to the corresponding data line DL by establishing the feedback loop including the first output switch SW1_{O} and the first feedback SW1_{F}. That is, the first output switch SW1_{O} connects the output node OUT1 to the output pad P of the source driver according to a first control signal, and the first feedback switch SW1_{F} connects the negative input node IN1− to the output pad P according to the first control signal. The first control signal is for example generated according to a transfer pulse (TP1) signal generated by a timing controller of the display (not shown in FIG. 3). The TP1 signal is used to indicate the source driver that it is time to output the analog voltages to drive the data lines. The source driver generates the first control signal according to the TP1 signal, for example, by delaying for an appropriate duration as various design requirements. Please note that all the switches, including the first output switch SW1_{O} and the first feedback SW1_{F}, are included in the feedbacks. Hence, the equivalent output resistance of the channel 300 can be reduced in a great deal.

During the driving period that the source driver drives one horizontal line of the display, the output multiplexer, including the first output switch SW1_{O} and the first feedback switch SW1_{F}, is first set in the first connection mode and then is set in the second connection mode. A period corresponding to a horizontal line is separated into a first period and a second period following the first period. The first connection mode is established in the first period and the second connection mode is established in the second period. The source driver outputs corresponding analog voltage to each pixel at the second period.

It should be noted that the first output switch SW1_{O} and the first feedback switch SW1_{F} can operate as multiplexers. That is, the first output switch SW1_{O} and the first feedback switch SW1_{F} can selectively connect the output node OUT1 and the negative input node IN1− to other output pads of the source driver, e.g., a second output pad or a third output pad (not shown in FIG. 3), etc.

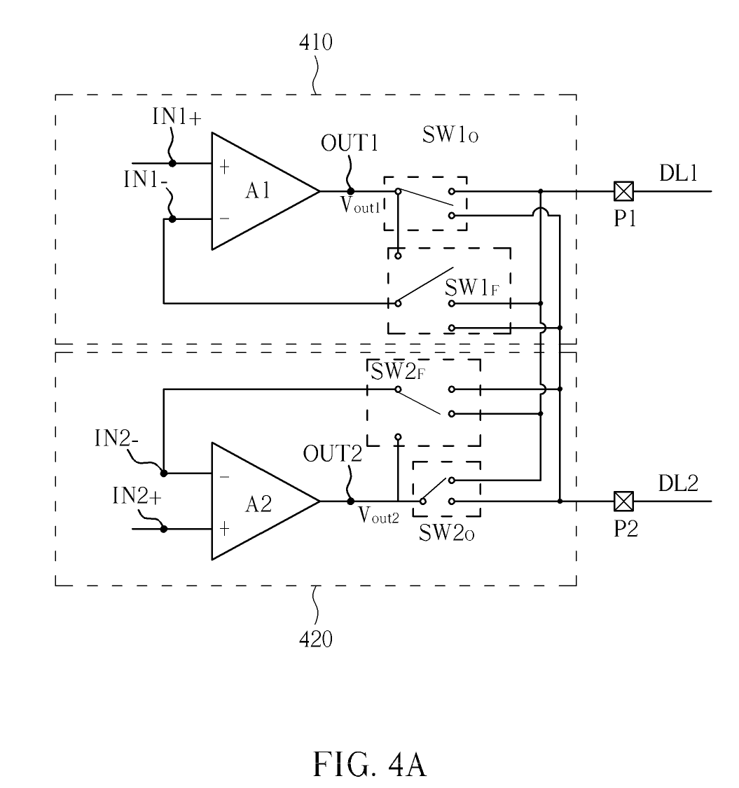

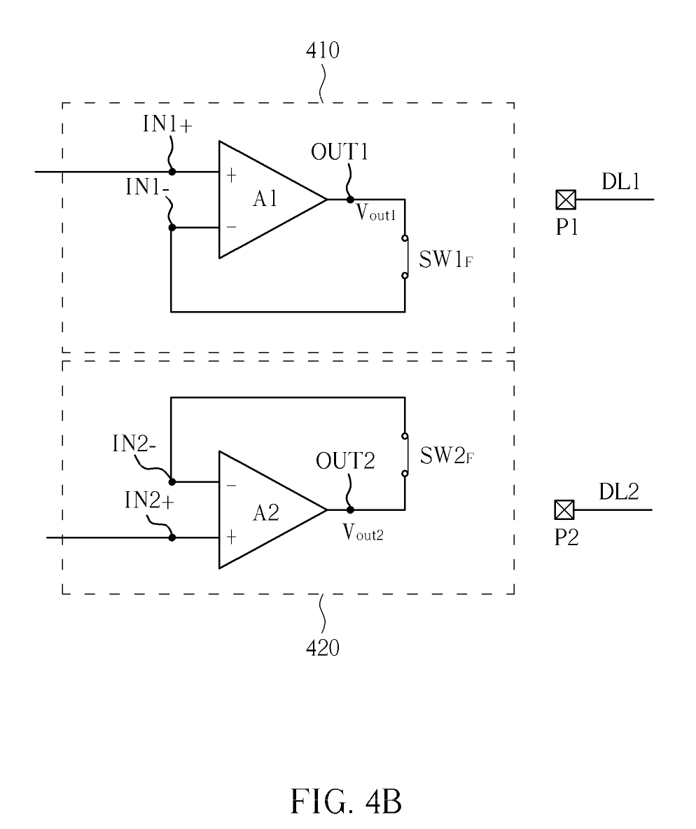

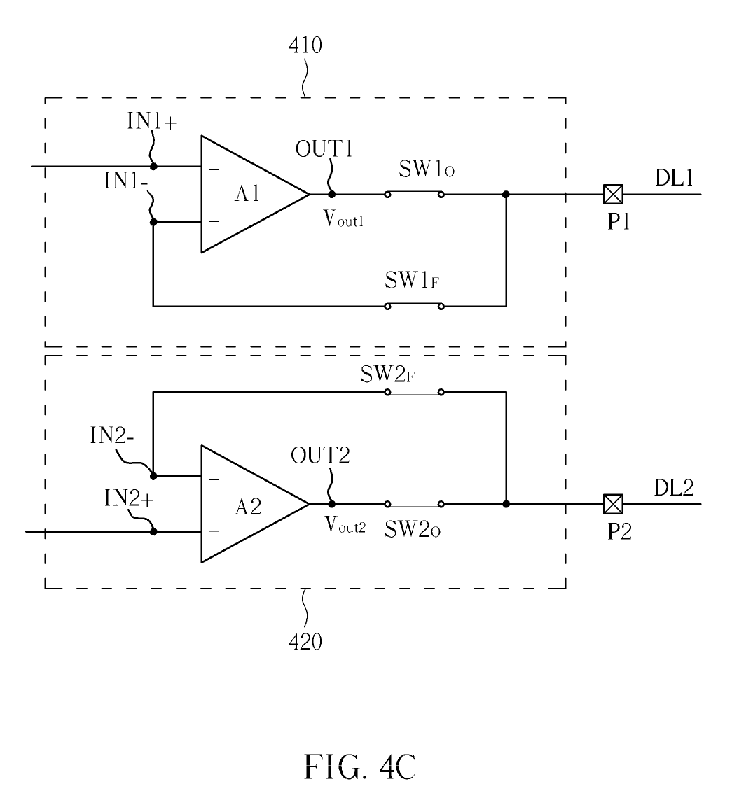

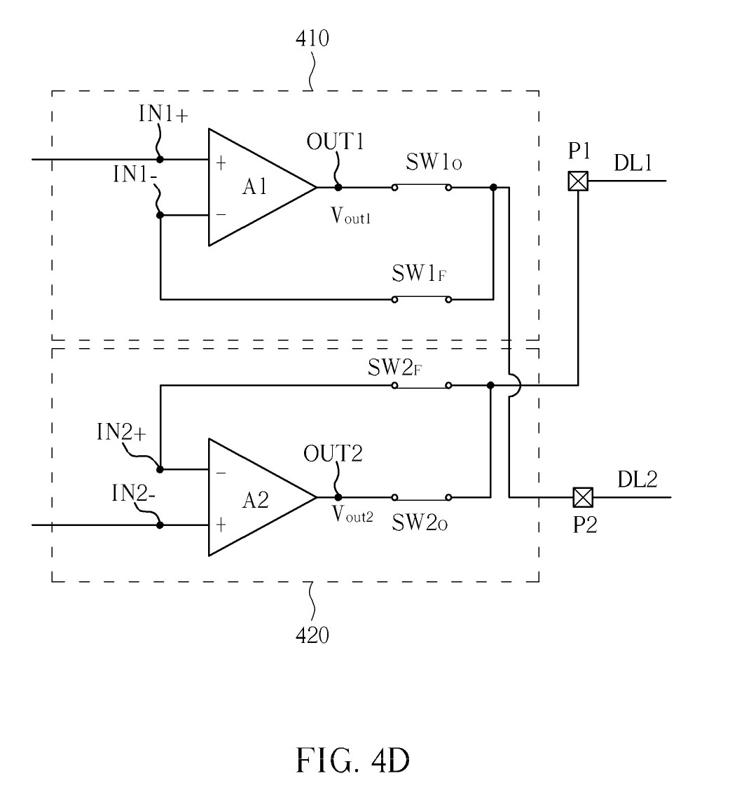

FIG. 4A is an exemplary diagram showing an output stage of two channels of a source driver of a display according to another embodiment of the invention. The source driver comprises a channel 410 and a channel 420. The channel 410 comprises a first amplifier A1, a first output switch SW1_{O}, and a first feedback switch SW1_{F}. The channel 420 comprises a second amplifier A2, a second output switch SW2_{O}, and a second feedback switch SW2_{F}. The second amplifier A2 includes a positive input node IN2+ for receiving an analog voltage, a negative input node IN2−, and an output node OUT2. The second output switch SW2_{O} selectively connects an output node OUT2 of the second amplifier A2 to one of the output pads (e.g., P1 or P2) of the source driver. The second feedback switch SW2_{F} connects the negative input node IN2− to one of the output pads or the output node OUT2. As mentioned above, for reducing the RC-time constant, the second amplifier A2 is implemented using any amplifier having high gain, e.g. an operational amplifier. Please note that the implementation shown in FIG. 4A merely serves as an example to describe the invention, and it is not meant to be a limitation of the invention. In addition, only the components related to the invention are shown in FIG. 4A for simplicity.

The channels 410 and 420 drive data lines DL1 and DL2 of the display. As known by people skilled in the art, the field polarity of a pixel has to be changed frequently (i.e., the polarity inversion mechanism). For example, a pixel is driven by the source driver with a first voltage higher than a common voltage in a first frame time such that the field polarity of the pixel is directed in a first direction (say, positive), and with a second voltage lower than the common voltage in a second frame time such that the field polarity of the pixel is directed in a second direction opposite to the first direction (say, negative). If the first and second voltages are both provided by one channel, the output voltage range of the channel has to cover the first and second voltages, which means the amplifier of the channel—for instance, the first amplifier A1 in FIG. 3—must have a wider output range. An amplifier having a wider output range, however, is more difficult to implement than an amplifier having a narrower output range. Hence, two amplifiers having a wider output range can be replaced with two amplifiers having narrower and different output ranges. When the pixel has to be driven with a first voltage higher than a common voltage, the pixel is driven by one channel having a higher output range. When the pixel has to be driven with a second voltage lower than the mean voltage, the pixel is driven by another channel having a lower output range. For example, in FIG. 4A, the first amplifier A1 outputs the output voltage V_{OUT1} belonging to a first voltage range, and the second amplifier A2 outputs the output voltage V_{OUT2} belonging to a second voltage range that is different from the first voltage range. The operation will be detailed below.

Similarly, during the driving period that the source driver drives one horizontal line of the display, the output multiplexer is first set in the first connection mode and then is set in the second connection mode. A period corresponding to a horizontal line is separated into a first period and a second period following the first period. The first connection mode is established in the first period and the second connection mode is established in the second period. The source driver outputs corresponding analog voltages to each data line (e.g. DL1 and DL2) at the second period.

FIG. 4B is an exemplary diagram of a first connection mode of the channels in FIG. 4A. Please note that, in FIG. 4B, only conducting paths are shown for simplicity. In the first connection mode, the channels 410 and 420 do not output signals to the output pads, and the output nodes of the amplifiers A1 and A2 are simply connected back to the negative input nodes to achieve stability. The first output switch SW1_{O} disconnects the output node OUT1 from output pads of the source driver according to a third control signal, and the first feedback switch SW1_{F} connects the negative input node IN1− to the output node OUT1 according to the third control signal. Likewise, the second output switch SW2_{O} disconnects the output node OUT2 from the output pads of the source driver according to the third control signal, and the second feedback switch SW2_{F} connects the negative input node IN2− to the output node OUT2 according to the third control signal. The third control signal is generated corresponding to TP1.

FIG. 4C is an exemplary diagram of a second connection mode corresponding to a first polarity of the channels in FIG. 4A. Please note that, in FIG. 4C, only conducting paths are shown for simplicity. In the second connection mode corresponding to the first polarity, the first amplifier A1 outputs the output voltage Vₒᵤₜ₁ belonging to a first voltage range to a first output pad P1 of the source driver, and the second amplifier A2, outputs the output voltage Vₒᵤₜ₂ belonging to a second voltage range that is different with the first voltage range to a second output pad P2 of the source driver. The first output pad P1 connects to a first data line DL1, and the second output pad P2 connects to a second data line DL2. The first output switch SW1_{O} connects the output node OUT1 to the first output pad P1 of the source driver according to a first control signal. The first feedback switch SW1_{F} connects the negative input node IN1− to the first output pad P1 according to the first control signal. The second output switch SW2_{O} connects the output node OUT2 to a second output pad P2 of the source driver according to the first control signal. The second feedback switch SW2_{F} connects the negative input node IN2− to the second output pad P2 according to the first control signal. The first control signal is generated corresponding to the TP1 and a polarity signal.

FIG. 4D is an exemplary diagram of a second connection mode corresponding to a second polarity of the channels in FIG. 4A. Please note that, in FIG. 4D, only conducting paths are shown for simplicity. In the second connection mode corresponding to the second polarity, the first amplifier A1 outputs the output voltage Vₒᵤₜ₁ belonging to the first voltage range to the second output pad P2 of the source driver, and the second amplifier A2 outputs the output voltage Vₒᵤₜ₂ belonging to the second voltage range different from the first voltage range to the first output pad P1 of the source driver. The first output switch SW1_{O} connects the output node OUT1 to the second output pad P2 of the source driver according to a second control signal. The first feedback switch SW1_{F} connects the negative input node IN1− to the second output pad P2 according to the second control signal. The second output switch SW2_{O} connects the output node OUT2 to the first output pad P1 of the source driver according to the second control signal. The second feedback switch SW2_{F} connects the negative input node IN2− to the first output pad P1 according to the second control signal. The second control signal is generated corresponding to the TP1 and the polarity signal.

To conclude, the embodiments of the invention provide channels of the source driver of display having at least one feedback loop at the same time such that the bandwidth and stability of the channel can be improved greatly.

Those skilled in the art will readily observe that numerous modifications and alterations of the device and method may be made while retaining the teachings of the invention.

What is claimed is:

1. A source driver of a display, comprising:
a first channel, comprising:
a first amplifier;
a first output switch selectively connecting an output node of the first amplifier to one of a plurality of output pads of the source driver; and
a first feedback switch connecting an input node of the first amplifier to one of the output pads or the output node of the first amplifier.

2. The source driver of claim 1, further comprising:
a second channel, comprising:
a second amplifier;
a second output switch selectively connecting an output node of the second amplifier to one of the output pads of the source driver; and
a second feedback switch connecting an input node of the second amplifier to one of the output pads or the output node of the second amplifier.

3. The source driver of claim 2, wherein the first output switch, the first feedback switch, the second output switch, and the second feedback switch are controlled by a control signal generated according to a transfer pulse signal and a polarity signal of the display.

4. The source driver of claim 3, wherein:
the first output switch connects the output node of the first amplifier to a first output pad of the source driver according to a control signal;
the first feedback switch connects the input node of the first amplifier to the first output pad according to the control signal;
the second output switch connects the output node of the second amplifier to a second output pad of the source driver according to the control signal; and
the second feedback switch connects the input node of the second amplifier to the second output pad according to the control signal.

5. The source driver of claim 3, wherein:
the first output switch connects the output node of the first amplifier to a second output pad of the source driver according to a control signal;
the first feedback switch connects the input node of the first amplifier to the second output pad according to the control signal;
the second output switch connects the output node of the second amplifier to a first output pad of the source driver according to the control signal; and
the second feedback switch connects the input node of the second amplifier to the first output pad according to the control signal.

6. The source driver of claim 3, wherein:
the first output switch does not connect the output node of the first amplifier to one of output pads of the source driver according to a control signal;
the first feedback switch connects the input node of the first amplifier to the output node of the first amplifier according to the control signal;
the second output switch does not connect the output node of the second amplifier to one of the output pads of the source driver according to the control signal; and
the second feedback switch connects the input node of the second amplifier to the output node of the second amplifier according to the control signal.

7. The source driver of claim 2, wherein an output range of the first amplifier and an output range of the second amplifier are different.

8. The source driver of claim 1, wherein the first output switch and the first feedback switch are controlled by a control signal generated according to a transfer pulse signal of the display.

9. The source driver of claim 8, wherein in a first connection mode, the first output switch connects the output node of the first amplifier to a first output pad of the source driver, and the first feedback switch connects the input node of the first amplifier to the first output pad.

10. The source driver of claim 1, wherein the first output switch does not connect the output node of the first amplifier to one of output pads of the source driver according to the control signal, and the first feedback switch connects the input node of the first amplifier to the output node of the first amplifier according to the control signal.

11. The source driver of claim 1, wherein a period corresponding to a horizontal line of the display is separated into a first period and a second period following the first period, the source driver outputs corresponding pixel data to pixel of the display at the first period.
